(19) United States
(12) Patent Application Publication
(10) Pub. No.: US 2014/0281948 A1
(43) Pub. Date: Sep. 18, 2014

(54) INFORMATION DISPLAYING APPARATUS, INFORMATION EDITING METHOD AND NON-TRANSITORY COMPUTER-READABLE STORAGE MEDIUM

(71) Applicant: KONICA MINOLTA, INC., Tokyo (JP)

(72) Inventors: Ryou SEI, Tokyo (JP); Tetsuhiro SHIBATA, Hamamatsu-shi (JP)

(73) Assignee: KONICA MINOLTA, INC., Tokyo (JP)

(21) Appl. No.: 14/210,323

(22) Filed: Mar. 13, 2014

(30) Foreign Application Priority Data
Mar. 15, 2013 (JP) 2013-052738

(51) Int. Cl. G06F 17/24; G06F 3/0488

(52) U.S. Cl. CPC G06F 17/24; G06F 3/04883
USPC 715/268

(57) ABSTRACT

Provided is an information displaying apparatus, an information editing method and a non-transitory computer-readable storage medium storing an information editing program. The information displaying apparatus includes a display section configured to display a document screen, and an operating section configured to receive an input of additional information inputted into the document displayed on the display section. The information displaying apparatus further includes an input area defining section configured to define an area or areas on the display section, where each area includes the additional information inputted through the operating section. The information displaying apparatus further includes an information extracting section configured to extract the additional information inputted into the each area and document information being information of the document displayed in the each area, and an associating processing section configured to register the additional information and the document information with being associated together.

This application is based on Japanese Patent Application No. 2013-052738 filed on Mar. 15, 2013, in the Japan Patent Office, the entire content of which is hereby incorporated by reference.

### TECHNICAL FIELD

The present invention relates to an information displaying apparatus, an information editing method and a non-transitory computer-readable storage medium storing an information editing program. In particular, the present invention relates to an information displaying apparatus capable of inputting additional information into a document, an information editing method of editing additional information and a non-transitory computer-readable storage medium storing an information editing program.

### BACKGROUND

In recent years, there are provided apparatuses well known as an apparatus to display documents, such as apparatuses having functions to allow a user to perform handwriting on a document with a touch panel and to add information on a document with a keyboard and a mouse. Further, some of such apparatuses are provided with functions to store each page of documents on which handwriting has been performed or additional information has been put and to display pages of documents on which handwriting has been performed or additional information has been put, in a list style.

With regard to such a display apparatus, for example, Japanese Unexamined Patent Publication (JP-A) No. 2012-155739 discloses an electronic pen system which includes a plurality of sheets of paper, a plurality of electronic pens and a terminal unit. The electronic pen system is constituted as follows. On each of the plurality of sheets, a coded pattern made unique depending on positions is printed. Each of the plurality of electronic pens is configured to read the coded pattern printed on the sheet, to calculate position coordinates of the tip of the pen, and to transmit entry information including the position coordinates and a unique pen ID. The terminal unit is configured to receive the entry information transmitted from the electronic pen, and to process the entry information. The terminal unit includes a memory to memorize entry information for each pen ID or each user ID associated with a corresponding pen ID, and a region designating section to receive a designation of a region of a sheet on a display screen of a display section. The terminal unit further includes a processing section to reproduce the entry information as handwriting for each pen ID or each user ID associated with a corresponding pen ID and to operate the display section to display the handwriting. The processing section is configured to select, from among pen IDs and user IDs associated with corresponding pen IDs, one for which entry information exists in a region designated by the region designating section, and to operate the display section to display, in a list style, the entry information on each of the selected sheets as handwriting together with a user name associated with the pen ID or the user ID.

Further, JP-A No. 2011-004356 discloses an image forming apparatus which includes a document reading section, a control section and an image forming section. The image forming apparatus is constituted as follows. The document reading section is configured to read plural sheets of a document and to produce image data representing images on the plural sheets of the document. The control section is configured to produce data of a gathering of images based on the image data of the plural sheets of document read by the document reading section in order to put images on a designated number of sheets of the document on a single recording sheet. The control section is further configured to judge whether an image of each of the sheets of the document includes an extraction region or not, and to produce extracted image data based on image data of a sheet of the document judged to include the extraction region in order to put images included in the extraction regions on a single recording sheet. The image forming section is configured to form an image on a recording sheet based on the data of a gathering of images and the extracted image data in response to instructions the control section.

Furthermore, JP-A No. 2003-256475 discloses an image data administering apparatus which collects and accumulates a plurality of image data and displays and/or prints these image data if needed. The image data administering apparatus includes a list editing section configured to extract an image portion at a given position with given size from each of the plurality of image data and put the extracted image portions together so that the image portions can be outputted as a list.

In addition, JP-A No. 2005-063428 discloses an information displaying apparatus which includes an acquiring section, an accepting section and a displaying section. The acquiring section is configured to acquire all or a part of Web data constituting a plurality of Web pages obtained from one or more Web servers connected to a network. The accepting section is configured to accept from a user an instruction to specify information to be extracted from the Web data acquired by the acquiring section. The indicating section is configured to extract the information specified by the instruction received by the accepting section from all of the Web data acquired by the acquiring section, to constitute a single screen by using the extracted information, and to display the screen.

On a document used as a display target in the above apparatuses, an important portion and a not so important portion exist. Therefore, when reading through a document, a reader often makes marking (adding figures, such as an underline and a frame line) and adds characters such as comments in portions of the document such as a portion in which the reader has an interest and a portion which the reader must understand. Subsequently, the reader quotes the portions on which figures and characters have been added for reutilization or utilizes the portions for a check list.

However, conventional apparatuses were merely configured to store each page of a document on which figures and characters have been added or to display pages of the document in a list style. If a reader adds a figure or characters to a part of a page of the document in such an apparatus, the apparatus stores or displays also unwanted parts of the page. Therefore, it was difficult for a reader to find out parts on which figures and characters have been added effectively. Such an apparatus displayed the list of pages wherein parts on which figures and characters have been added are displayed in small size. Therefore, it was difficult for a reader to confirm the contents of the parts on which markings are added. In other words, conventional apparatuses employed a database structure to administer a document on which figures and characters have been added with handling each page of the document as one unit, which caused a difficulty of performing effective administration only on important parts.

This situation requires the following operations for a user. That is, a user prints documents on which figures and characters are added, cuts out only portions including the added figures and characters from the printed documents, and patches the cut-out portions into a list. Alternatively, a user takes an image of a document on which figures and characters are added by screenshot, and patches portions including the added figures and characters into a list by copy and paste operations in a computing device. Those operations were complicated and needed users to spend a lot of time, which was a problem. The present invention seeks to solve the problem.

### SUMMARY

There are disclosed illustrative information displaying apparatuses, information editing methods and non-transitory computer-readable media each storing an information editing program.

An illustrative information displaying apparatus reflecting one aspect of the present invention is an information displaying apparatus comprising: a display section configured to display a document screen showing a document thereon; and an operating section configured to receive an input of additional information inputted into the document displayed on the display section. The information displaying apparatus further comprises an input area defining section configured to define an area or areas on the display section, where the area or areas includes the additional information inputted through the operating section. The information displaying apparatus further comprises an information extracting section configured to extract the additional information inputted into each of the area or areas and document information being information of the document displayed in the each of the area or areas; and an associating processing section configured to register the additional information and the document information with being associated together.

An illustrative information editing method reflecting one aspect of the present invention is a method of editing information by using an information displaying apparatus. The information displaying apparatus includes a display section configured to display a document screen showing a document thereon and an operating section configured to receive an input of additional information inputted into the document displayed on the display section. The method comprises: defining an area or areas on the display section, where the area or areas includes the additional information inputted through the operating section; extracting the additional information inputted into each of the area or areas and document information being information of the document displayed in the each of the area or areas; and registering the additional information and the document information with being associated together.

An illustrative non-transitory computer-readable storage medium reflecting one aspect of the present invention stores an information editing program to be executed in an information displaying apparatus. The information displaying apparatus includes a display section configured to display a document screen showing a document thereon and an operating section configured to receive an input of additional information inputted into the document displayed on the display section. The program, when being executed by a processor of the information displaying apparatus, causes the information displaying apparatus to perform the above information editing method.

Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a block diagram showing a constitution of an information displaying apparatus relating to one embodiment of the present invention;

FIG. 2 is a block diagram showing the functions of a system control section of the information displaying apparatus relating to one embodiment of the present invention;

FIG. 3 is a flowchart showing the actions (a list creating process) of the information displaying apparatus relating to one embodiment of the present invention;

FIG. 4 is a flowchart showing the actions (an input area defining process) of the information displaying apparatus relating to one embodiment of the present invention;

FIG. 5 is a flowchart showing the actions (a moving process from a list to a document page) of the information displaying apparatus relating to one embodiment of the present invention;

FIG. 6 is a flowchart showing the actions (a moving process from a document page to a list) of the information displaying apparatus relating to one embodiment of the present invention;

FIG. 7 is a flowchart showing the actions (a linking process) of the information displaying apparatus relating to one embodiment of the present invention;

FIGS. 8A and 8B are illustrations showing a display example of document pages relating to one embodiment of the present invention;

FIGS. 9A and 9B are illustrations showing a display example (an example in the case of displaying document information and additional information with being overlapped together) of a list relating to one embodiment of the present invention;

FIGS. 10A and 10B are illustrations showing a display example (an example in the case of displaying document information and additional information separately) of a list relating to one embodiment of the present invention;

FIGS. 11A and 11B are illustrations showing a display example (an example of sorting items of the list according to properties) of a list relating to one embodiment of the present invention;

FIG. 12 is an illustration showing an example of storing the list relating to one embodiment of the present invention;

FIG. 13 is an illustration showing another display example of a list relating to one embodiment of the present invention;

FIG. 14 is an illustration showing movement between a document page and a list relating to one embodiment of the present invention;

FIGS. 15A and 15B are illustrations showing a relationship among a document page, a list, and reference information relating to one embodiment of the present invention.

FIG. 16 is an illustration showing an example of defining an input area relating to one embodiment of the present invention (in the case where a closed figure is inputted);

FIG. 17 is an illustration showing an example of defining an input area relating to one embodiment of the present invention (in the case where a non-closed figure is inputted);

FIG. 18 is an illustration showing an example of defining an input area relating to one embodiment of the present invention (in the case where plural figures are inputted);

FIG. 19 is an illustration showing an example of defining an input area relating to one embodiment of the present invention (in the case where plural figures are inputted with a space between them);

FIG. 20 is an illustration showing an example of defining an input area relating to one embodiment of the present invention (in the case where a straight line is inputted);

FIG. 21 is an illustration showing an example of defining an input area relating to one embodiment of the present invention (in the case where characters are inputted);

FIG. 22 is an illustration showing an example of defining an input area relating to one embodiment of the present invention (in the case where an input area is modified); and

FIG. 23 is an illustration showing an example of defining an input area relating to one embodiment of the present invention (in the case where a document includes paragraphs).

### DETAILED DESCRIPTION

Illustrative embodiments of information displaying apparatuses, information editing methods and non-transitory computer-readable media each storing an information editing program will be described with reference to the drawings. It will be appreciated by those of ordinary skill in the art that the description given herein with respect to those figures is for exemplary purposes only and is not intended in any way to limit the scope of potential embodiments may be resolved by referring to the appended claims.

According to information displaying apparatuses, information editing methods and non-transitory computer-readable media each storing an information editing program as the illustrative embodiments of the present invention, portions on which figures or characters are added can be efficiently managed.

The reasons are as follows. An information displaying apparatus capable of displaying documents and inputting additional information, such as figures and characters on the documents, includes structures configured to perform the following processing. The processing includes defining an area or areas to which additional information has been inputted, extracting additional information and document information of each of the area or areas; optionally extracting property information of the additional information (or property information of the additional information and the document information), and registering the additional information, the document information and the property information with being associated together. The processing can further include displaying a list screen showing a list including additional information, document information and property information grouped according to the area or areas, and displaying the list screen and one of various screens such that a user can move between a list screen and the other screen, where the various screens includes the document screen showing a page showing a source of an item of the list and a reference information screen showing a reference information.

In this way, the information displaying apparatus can gather document information and additional information so as not to display areas of the document information excluding the additional information, which allows users to manage only necessary information. Further, the information displaying apparatus allows a user to move from the list screen to a screen showing the document page as the source of an item of the list or a screen showing a reference information or move inversely, which allows a user to confirm document information relating to the additional information easily and attain promotion of their comprehension and improvement of their workability.

As illustrated in the description about the background, in conventional information displaying apparatuses, users added figures such as an underline and a frame line, and characters such as comments to an important portion of a document, and, subsequently, quoted portions of the documents to which those pieces of information have been added for reutilization or utilized the portions in place of a check list. However, the conventional information displaying apparatuses employed a database structure to manage a document to which figures and characters have been added with handling each page of the document as one unit. Accordingly, in the case where a user add figures or characters into a part of a page, the conventional information displaying apparatuses stored or displayed also unwanted area of the page, which caused a difficulty of searching the added parts and confirming the contents of the added parts.

In view of the problem, in one embodiment of the present invention, there is provided an information displaying apparatus capable of inputting additional information, such as figures and characters by handwriting or by the use of a keyboard and a mouse. The information displaying apparatus is configured to define an area or areas to which the additional information is added, extract document information and the additional information from each of the area or areas and registers the document information and the additional information with being associated together. Further, the information displaying apparatus may be configured to extract property information from the additional information (or the additional information and the document information) and register the property information of the additional information and the property information of the document information with being associated with the document information and the additional information of the corresponding area or areas. Herein, the property information of the additional information includes color of each of figures and characters, size of characters, thickness of lines, type of a pen and a character string extracted from a document on the portion on which figures and characters are added. The property information of the document information includes the page number of the document, the file name of the document file, the production date of the file and key words extracted from the document, and the like.

Further, the information displaying apparatus may be configured to create a list including images of document information and additional information and property information grouped according to the area or areas and to display the list thereon. The information displaying apparatus may be configured to sort the plural images according to property information and extract only images having predetermined property again to display the list of the images. Furthermore, the information displaying apparatus may be configured to, on displaying the list, allow a user to select one of a display style that the document information the additional information are displayed as images each including the document information and the additional information combined together and a display style that the document information the additional information are displayed as separated images.

Further, the information displaying apparatus may be configured to, in response to receiving a selection of an image or a property information on a screen showing the list, allow a user to move to a screen showing a document page corresponding to the selected image or to a screen showing reference information registered with being associated with the document page corresponding to the image. Alternatively, the information displaying apparatus may be configured to, in response to receiving a predetermined operation on the screen showing the document page as the destination of the movement or on the screen showing the reference information as the destination of the movement, allow a user to return to the list screen.

### Example

In order to describe the above-mentioned embodiments of the present invention in more detail, description will given to an information displaying apparatus, an information editing method, and a non-transitory computer-readable medium storing an information editing program relating to an example of the present invention with reference to FIGS. 1 to 23. FIG. 1 is a block diagram showing a constitution of an information displaying apparatus of the present example, and FIG. 2 is a block diagram showing functions of a system control section. Further, each of FIGS. 3 to 7 is a flowchart showing the actions of the information displaying apparatus of the present example, each of FIGS. 8A to 15B is an illustration showing a display example of a document page or a list, and each of FIGS. 16 to 23 is an illustration for describing a technique to define an input area.

As shown in FIG. 1, an information displaying apparatus of the present example includes a system control section 101, a data recording section 102, a communicating section 103, an operating section 104, an input information processing section 105, an input device 106, a display processing section 107 and a display device 108.

The system control section 101 includes a ROM (Read Only Memory) which stores control programs, a CPU (Central Processing Unit) configured to execute control programs, and a RAM (Random Access Memory) which stores temporarily data necessary for executing control programs. The system control section 101 is configured to perform control for the whole of the system, mainly such as control for transmission and reception of data, instructions for storage and read-out of data, instructions for displaying data onto the display device 108, input of operation instruction by a system user through the operating section 104 and the input device 106, and instruction determination.

In particular, in the present example, as shown in FIG. 2, the system control section 101 is configured to work as an input area defining section 101a, an information extracting section 101b, an property extracting section 101c and an associating processing section 101d.

The input area defining section 101a is configured to acquire operation information of handwritten input or operation information of a keyboard and a mouse from the input device 106 and the operating section 104, to define an area or areas (hereinafter, referred as an input area or input areas) each including information such as figures and characters (hereinafter, referred as additional information) inputted into a document by a user of the information displaying apparatus, based on the acquired operation information, and to output the coordinates of each of the input area or input areas on the display device 108. Further, the input area defining section 101a is configured to, on or after defining the input area or input areas, correct at least one of size or shape of the size of each input area in accordance with the document currently displayed on the display device 108. For example, when the boundary line of an input area overlaps with characters in a document, the size of the input area is expanded such that the whole of the characters is accommodated in the input area.

The information extracting section 101b is configured to extract additional information inputted in each input area and the information of a document (hereafter, called as document information) displayed on each input area based on the coordinates outputted from the input area defining section 101a, and to pass the extracted information to the property extracting section 101c. That is, the document information does not correspond to the whole contents of a document in a displayed page and corresponds to a part of the document.

The property extracting section 101c is configured to define the color of each of a figure and a character, the size of the character, and the thickness of a line, the type of a pen, and the like in the additional information based on the above operation information, and to extract them as the property information of the additional information. For example, when a user selects a red color pen with a size of one point in the input device 106 and add a frame line and characters into the document with the pen, the property extracting section 101c extracts the information of “1 pt” and “red” based on the operation information, and sets the extracted information as the property information of the additional information. Further, the property extracting section 101c is configured to analyze a document, to define a character string (which may be one character or multiple characters) extracted from a portion of the document, in which a figure and characters are added as additional information, and to extract them as the property information of the additional information. For example, when the above frame line is added, the property extracting section 101c acquires the document information enclosed by the frame line from the information extracting section 101b and analyzes the document information, and then the property extracting section 101c extracts a character string used frequently, a character string with a large size, a character string with a conspicuous color, a character string described at the head of a line of writing, and the like from the document information, and sets the extracted character string as the property information of the additional information. Furthermore, the property extracting section 101c is configured to define the page number of the document, the file name of a document file, the production date of a file, key words (a character string frequently used through the whole of a document, a character string with a large size, a character string with a conspicuous color, a character string in the title, and a character string described at the head of a page, a paragraph, and a line of writing) extracted from the document, and the like, and to extract them as the property information of the document information.

The associating processing section 101d is configured to create an image in which the additional information and the document information both extracted by the information extracting section 101b are combined together or create the individual images of them. The associating processing section 101d is further configured to create, if needed, a list in which the each created image is associated with the corresponding property information extracted by the property extracting section 101c, to store the list as a file into the data recording section 102 or to store into the data recording section 102 a document file in which the list is added as a new page of the document, and to operate the display device 108 to display the screen of the list (the list screen) thereon. Further, when an image or property information is clicked on the list screen, the associating processing section 101d is configured to define a document page corresponding to the image or reference information linked with the document page, and to operate the display device 108 to display the screen of the document page (document page screen) or the screen of the reference information thereon. Furthermore, when a prescribed operation (for example, the depression of a return button) is performed on one of the screen of the document page and the screen of the reference information, the associating processing section 101d is configured to also perform control to allow a user to move to the other of the screens, that is, control to display the list screen being the source of the movement onto the display device. In addition, when another additional information is inputted on one of the list screen and the document page screen, the associating processing section 101d is configured to also perform control to reflect the another additional information on the other screen.

The data recording section 102 includes a HDD (Hard Disk Drive) and the like, and is configured to store document files, display data to be displayed on the display device 108, the operation information of the input device 106 and the operating section 104, set-up information to be used in the system control of the information displaying apparatus, a list in which the images are associated with property information and the like.

The communicating section 103 includes a NIC (Network Interface Card) and the like, and is configured to perform the transmission and reception of a document file, the transmission of a list, and the like in accordance with the instruction of the system control section 101.

The operating section 104 includes a hard key, a switch, and the like, and is configured to receive operations performed by a user of the information displaying apparatus, such as an operation to change a content displayed on the display device 108 and an operation to set up a system.

The input information processing section 105 is configured to acquire the information of an operation performed by a user of the information display apparatus through the input device 106 and the operating section 104, and to notify the information to the system control section 101.

Examples of the input device 106 include a pen input device of an electric induction type and a touch panel, which is arranged on the display section 108 described later, of an electrostatic capacitance detection type or a resistance film type. The input device 106 enables a user of the information displaying apparatus to input handwritings as additional information such as a figure and characters into a document.

The display processing section 107 is configured to perform control to display the display data on the display device 108 in accordance with instructions of the system control section 101.

Examples of the display device 108 include a display device of an electrophoresis type utilized in an electronic paper and a LCD (Liquid Crystal Display), and the display device 108 is configured to display a document page and the above list in accordance with instructions of the display processing section 107. Here, the display device of an electrophoresis type can retain the display content without consuming electric power in a displaying state and has a feature that electric power is consumed at the time of renewal the display.

Incidentally, the input information processing section 105 and the display processing section 107 are constituted as hardware in FIG. 1. Alternatively, the input information processing section 105 and the display processing section 107 may be provided by executing a control program which, when being executed, causes the system control section 101 to work as those sections.

Hereafter, the actions of the information displaying apparatus of the present example will be described. First, with reference to the flowchart of each of FIGS. 3 and 4, description will be given to procedures to create a list in which an image of each of additional information and document information is associated with property information. The CPU incorporated in the system control section is configured to perform the processing shown in each of FIG. 3 and FIG. 4 by executing control programs memorized in the ROM.

In advance of the creation of the above-mentioned list, the system control section 101 sends a document file received by the communicating section 103 or a document file recorded beforehand in the data recording section 102 to the display processing section 107. Then, the display processing section 107 operates the display device 108 to display any of pages contained in the document file. FIGS. 8A and 8B show a display example of pages of the document. FIG. 8A shows the state that the information displaying apparatus displays the first page of a document, and FIG. 8B shows the state that the information displaying apparatus displays the second page of the document.

Next, a user of the information displaying apparatus is allowed to input additional information, such as a figure and characters, into a screen of the page of the document displayed on the display device 108 by using the input device 106. For example, as shown in FIG. 8A, a blue line (in FIG. 8A, the blue line is expressed with a broken line) with a thickness of two points is drawn so as to enclose the characters of “EVIDENCE 1” displayed in the first page of the document. In addition, a red line (in FIG. 8A, the red line is expressed with a solid line) with a thickness of one point is drawn so as to enclose collectively the characters of “ALLEGATION 1” through “ALLEGATION 4”, and the characters of “THEIR ALLEGATION” are additionally written. Further, as shown in FIG. 8B, a blue line with a thickness of two points is drawn so as to enclose collectively the characters of “EVIDENCE 1” to “EVIDENCE 2” displayed in the second page of the document. In addition, a red line with a thickness of one point is drawn so as to enclose the characters of “ALLEGATION 3”, and the characters of “OUR ALLEGATION” are additionally written.

In such a state that the additional information is added on the document (a layer of the additional information is superimposed on a layer of the document), the system control section 101 (the input area defining section 101a) judges whether there is additional information on the first page of the document (S100). In concrete terms, when the input device 106 receives an input operation, since operation information is notified to the system control section 101 via the input information processing section 105, the system control section 101 can make based on the operation information a judgment about that the additional information has been inputted into which portion of which page of the document. Then, if there is no additional information on the page, the judgment target is changed to the next page (S110), and, the system control section 101 judges whether there is additional information in the next page (S100).

On the other hand, when there is additional information in the page, the system control section 101 (the input area defining section 101a) defines an input area into which the additional information has been input (S120). FIG. 4 shows a defining process for the input area. First, in the defining process, the system control section 101 (the input area defining section 101a) judges whether the initial input area of the page is an available input area to be registered into a list (S121). For example, the system control section 101 (the input area defining section 101a) judges whether the area is an area in which additional information is inputted so as to overlap with a document or an area in which additional information is inputted with a predetermined thickness (point) or color. Here, the reasons why this judgment is made are as follows. If all areas in each of which some kind of information is inputted are registered in a list, for example, a mark and the like which are inputted on a margin of a document also become a target to be registered in a list. Accordingly, it becomes difficult to collect only desired information into the list. Then, if the input area is not an available input area, the defining process proceeds to the next input area (S122). On the other hand, if the input area is an available input area, a size of the area to be extracted is determined, and then, the extracted size is output as coordinates on a screen (S123).

Examples of the methods of defining an input area will be described hereafter. As shown in FIG. 16, in the case where a closed figure 117 is inputted as additional information, a rectangle surrounded by four lines positioned separately near an upper end, a lower end, a right end, and a left end of the figure, is defined as an input area. Further, as shown in FIG. 17, also in the case where a non-closed figure 118 is inputted as additional information, a rectangle surrounded by four lines positioned separately near an upper end, a lower end, a right end, and a left end of the figure, is defined as an input area. At this time, if each the four lines is made to a line tangent to the upper end, the lower end, the right end, or the left end of the figure, such the situation may make it difficult to see the additional information or may cut out a part of characters on the document. Accordingly, assuming that the origin of the coordinates is located at the top-left point of the screen, the upper end and the left end of the input area of the input area are corrected to shift slightly close to the origin (for example, the coordinate of each of the upper end and the left end is reduced by n dots). On the other hand, the lower end and the right end are corrected to shift slightly apart from the origin (for example, the coordinate of each of the lower end and the right end the input area is increased by n dots). In this connection, this correction may be performed after document information is extracted at S130 mentioned later and conducted based on the extracted document information.

Furthermore, as shown in FIG. 18, in the case where two or more figures 119 are inputted as additional information, a rectangle surrounded by four lines positioned separately near an upper end, a lower end, a right end, and a left end of the whole of the figures, is defined as an input area. However, as shown in FIG. 19, in the case where the two or more input figures 120a and 120b are separated more than a predetermined distance from each other, each of the figures (in FIG. 19, the upper figure 120a and the lower figure 120b) is judged as independent additional information. Accordingly, a rectangle surrounded by four lines positioned separately near an upper end, a lower end, a right end, and a left end of each of the figures, is defined as an independent input area.

Moreover, in the case where a straight line 121 (underline and the like) extended in the arrangement direction of characters of the document is inputted as additional information, the additional information is judged as a line for the characters. Accordingly, as shown in FIG. 20, a rectangle including a row into which the line is inputted (in the case of an underline, a row positioned above the underline) is defined as an input area. Also, in the case where characters are inputted as additional information, as shown in FIG. 21, a rectangle surrounded by four lines positioned separately near an upper end, a lower end, a right end, and a left end of the characters 122, is defined as an input area.

In the above examples, an input area is shaped into a rectangle surrounded by four lines positioned separately near an upper end, a lower end, a right end, and a left end. However, the input area should not be limited to the rectangle. For example, in the case where a closed figure is inputted as additional information, the input area may be made an area having a boundary shaped into a figure approximate to the closed figure. Further, when an input area is defined as a rectangle, in the case where an area in which additional information is not inputted is larger than a predetermined size, the input area may be modified as follows. That is, as shown in FIG. 22, an input area is once defined as a rectangle based on additional information such as a figure 123, and then, the input area is modified into an area in which the above area is excluded. Subsequently, the modified area is finally defined as an input area. Furthermore, as shown in FIG. 23, in the case where a document includes a paragraph and additional information such as a figure 124 and the like is inputted into a part of the paragraph, an input area may be modified into an area including the whole of the paragraph.

Now, description returns to the flowchart of FIG. 3. In the flowchart, the system control section 101 (the information extracting section 101b) extracts the additional information and the document information in each input area defined in S120 (S130). In concrete terms, based on the operation information notified from the input information processing section 105, the system control section 101 extracts the additional information inputted in each input area. In addition, based on coordinates on the document screen and coordinates on the screen of each input area, the system control section 101 extracts the document information displayed in the each input area. Here, as mentioned above, in the case where the boundary of the input area overlaps with the characters of the document, in order to avoid the missing of a part of the characters, it is preferable to extract the document information in units of a row in the vertical direction and in units of a character in the horizontal direction (that is, the input area defining section 101a corrects the input area).

Next, the system control section 101 (the property extracting section 101c) extracts the property of the additional information (or the additional information and the document information) (S140). In concrete terms, with regard to the property of the additional information, based on the operation information notified from the input information processing section 105, the system control section 101 extracts information, such as the color of each of figures and characters, the size of characters, the thickness of lines, and the type of a pen with regard to the additional information. Further, the system control section 101 obtains the document information of each input area from the information extracting section 101b and analyzes it, and then the system control section 101 extracts information, such as a character string used frequently, a character string with a large size, a character string with a conspicuous color, and a character string described at the head of a row, in the document contents of the each input area. In addition, with regard to the property of the document information, the system control section 101 extracts information, such as the page number of the document in the page in which the additional information has been inputted, the file name of the document file, the production date of the file, key words extracted from the document (such as, a character string used frequently, a character string with a large size, a character string with a conspicuous color, a character string in the title, and a character string described at the head of a page, a paragraph and a row, through the whole of the document).

Next, the system control section 101 (the associating processing section 101d) defines the designation of a display style of the list (S150). Successively, in the case where the display style is designated so as to display the additional information and the document information with being overlapped together, the system control section 101 creates an image in which the additional information is combined with the document information for each input area (S160). Further, in the case where the display style is designated so as to display the additional information and the document information with being separated from each other, the system control section 101 creates an image of the document information and an image of the additional information separately for each input area (S170). In FIGS. 10A and 10B mentioned later, document information and additional information are displayed with being put in a vertical line. However, for example, in the case where a figure is inputted as additional information, the figure may be reduced in size, and its document information and the additional information may be displayed side by side horizontally.

Successively, the system control section 101 (the associating processing sections 101d) makes the image of the document information and the additional information associated with the property information, and registers them into the list (S180). Subsequently, the system control section 101 judges whether there is the next page (S190). In the case where there is the next page, the system control section 101 changes the page of the judgment target to the next page (S110), returns to S100, and repeats the same process.

FIGS. 9A and 9B show a display example of a list created in the above-mentioned process (in the case where the display style is designated so as to display the additional information and the document information with being overlapped together). In the list screen, displayed are images (at the portions indicated with symbols 110, 112, 114, and 116 in FIGS. 9A and 9B) in each of which document information and additional information are combined. Further, in the vicinity of each of the respective images, displayed is the property information (at the portions indicated with symbols 109, 111, 113, and 115 in FIGS. 9A and 9B) of the additional information (or the additional information and the document information). Further, FIGS. 10A and 10B show a display example of a list created in the above-mentioned process (in the case where the display style is designated so as to display the additional information and the document information separately). In the list screen, displayed are the respective separate images of document information and additional information (the images of the document information are displayed at the portions indicated with symbols 110a, 112a, 114a, and 116a in FIGS. 10A and 10B, and the images of the additional information are displayed at the portions indicated with symbols 110b, 112b, 114b, and 116b in FIGS. 10A and 10B). Further, in the vicinity of each of these images, displayed is the property information (at the portions indicated with symbols 109, 111, 113, and 115 in FIGS. 10A and 10B) of the additional information (or the additional information and the document information). In this way, document information excluded from the input area is not displayed on the list screen, which allows a user to find quickly the important document information for which the additional information is inputted and to confirm its content easily.

Moreover, each image registered in the list is associated with the property information of the additional information (or the additional information and the document information). Accordingly, each image also can be displayed with being sorted by utilizing this property information. FIGS. 11A and 11B show examples in which each image (in here, the combined image of document information and additional information) is sorted according to the property information of the additional information. FIG. 11A shows an illustrative screen of the sorted list. That is, a character string of “EVIDENCE” extracted from the document information of the input area is taken as the property information of the additional information to be used for the sorting process. Then, images (at the portions indicated with symbols 110 and 114 in FIG. 11A) including a character string of “EVIDENCE” in the property information (at the portions indicated with symbols 109 and 113 in FIG. 11A) are displayed in the list. FIG. 11B shows another illustrative example of the sorted list. That is, in this example, a character string of “ALLEGATION” extracted from the document information of the input area is taken as the property information of the additional information to be used for the sorting process. Then, images (at the portions indicated with symbols 112 and 116 in FIG. 11B) including a character string of “ALLEGATION” in the property information (at the portions indicated with symbols 111 and 115 in FIG. 11B) are displayed in the list. In this way, with the technique to sort images according to the property information and to display the sorted images, it allows a user to find quickly important document information for which desired additional information has been inputted and to confirm its content easily.

The list created in the above-mentioned process may be managed as another file other than the document file. Alternatively, the list may also be managed as a single document file in which the list is added as a new page into the document as shown in FIG. 12. In the case where the list is managed as a single document file in which the list is added to the original document, a new document file including the list may be created separately from the original document file. Alternatively, the list may be added into the original document to change the content of the original document. In the case where the list is managed with the document as a single file, such a file allows a user to move from one of the document page screen and the list screen to the other of those screens. Hereafter, description will be given to a method of moving between the document page screen and the list screen with reference to a flowchart in each of FIGS. 5 and 6

Movement from a List to a Document Page:

FIG. 5 is a flowchart which shows processing to change a screen displayed on the display device from the list screen to the document page screen. The CPU incorporated in the system control section performs the processing shown in FIG. 5 by executing a control program stored in the ROM.

As shown in the flowchart in FIG. 5, the system control section 101 (the associating processing section 101d) judges based on the operation information notified from the input information processing section 105 whether an image or property information is clicked on the list screen (S200). When an image or property information is clicked, the system control section 101 judges such a movement from the list screen to the document page screen has been instructed. Then, the system control section 101 defines a document page corresponding to the image based on the property information, and changes the current-displayed screen to the document page screen (S210).

Movement from a Document Page to a List:

FIG. 6 is a flowchart which shows processing to change a screen displayed on the display device from the document page screen to the list screen. The CPU incorporated in the system control section performs the process shown in FIG. 6 by executing a control program stored in the ROM.

As shown in the flowchart in FIG. 6, the system control section 101 (the associating processing section 101d) judges based on the operation information notified from the input information processing section 105 whether a predetermined prescribed operation (for example, depression of a button of “RETURN” disposed on the document page screen) is performed on the document page screen (S300). When the prescribed operation is performed, the system control section 101 judges such that a movement from the document page screen to the list screen has been instructed. Then, the system control section 101 changes the current-displayed screen back to the list screen as the source of the movement (S310).

FIG. 13 shows an example of movement between the list screen and the document page screen. When the image of “EVIDENCE 1” or the property information of “PAGE 1, BLUE, 2pt, EVIDENCE” on the list screen shown on the left-hand side of FIG. 13 is clicked, the document page screen of the first page, shown on the right-hand side of FIG. 13, corresponding to the image is displayed. On the contrary, under the condition that the document page screen shown on the right-hand side of FIG. 13 is currently displayed, when a button of “RETURN” on the document page screen of the first page is clicked, the list screen shown on the left-hand side of FIG. 13 is displayed. In this way, the information displaying apparatus is configured to display the list screen and the document page screen so as to allow a user to move from one of those screens to the other, which allows a user to find out desired additional information on the list screen and to confirm easily the content of a page of the document corresponding to the additional information, thereby improving the convenience of the user.

Further, the information displaying apparatus is configured to make the list associated with a document page according to its property information, which makes it possible to reflect another additional information inputted additionally into one of an input area of the document page screen and a corresponding area of the list screen to the other. For example, as shown in FIG. 14, when another additional information (here, the characters of “IMPORTANT!!!”) is further added into a portion at which additional information has been input on the list screen (or the document page screen) (in this example, on a portion of an image indicated with a symbol 112 in which an ellipse with a thickness of one point has been added to an area covering from “ALLEGATION 1” to “ALLEGATION 4”), the another additional information is reflected to the corresponding portion on the screen of the original document page (or the original list). In this way, if another additional information is inputted into an area of the screen of one of the list and the document page, the another additional information is reflected to the corresponding area on the screen of another one. Accordingly, even after the list has been created, another additional information can be inputted additionally freely, whereby a list with high utility value can be created.

As mentioned above, the description has been made to the case where an image on a list is associated with a document page corresponding to the image (a document page on which the document information displayed on the list is described). However, when the document information includes reference information (for example, the document is provided with a link to a Web page), the system control section may make the image on the list associated with a document page to which the document page corresponding to the image refers. The actions of the information displaying apparatus in that case will be described with reference to a flowchart in FIG. 7.

FIG. 7 is a flowchart showing processing to change a screen displayed on a display device from the list screen to the screen of the link destination. The CPU incorporated in the system control section performs the processing shown in FIG. 7 by executing a control program stored in the ROM.

The system control section 101 (the associating processing section 101d) judges whether there is link information in input areas (S400). For example, the system control section 101 judges whether a document page being the source of document information in the input area includes a hyperlink to jump to reference information on another document page, another document file, and an external Web page. Then, when there is reference information in an input area, the system control section 101 adds a link icon to the list screen (S410).

For example, as shown in FIG. 15A, in the case where a hyperlink is embedded in a document page and the document page screen is configured to jump to the Web page of the link destination in response to a click operation for the hyperlink, the system control section 101 operates the display section to display the document information including the hyperlink as an image on the list screen (that is, the document information is displayed in the state that the position information of the hyperlink is deleted). Therefore, even if a user clicks the portion of the hyperlink in the image, the user cannot jump to the Web page. In view of this matter, the associating processing section 101d extracts the position information of the hyperlink from the document information, and registers the position information and the link icon (a button on which the characters of “LINK” is written in FIG. 15A) with being associated together such that a user can jump to the Web page when clicking the link icon. FIG. 15B shows an example of the list screen on which such a link icon is added. On the list screen, the document information, the additional information, and the property information are displayed with being associated with each other. Under the condition that a document page being the source of each piece of document information includes reference information, the system control section 101 operates the display device to display a link icon to move to the screen of the reference information on the list screen. Further, the system control section 101 operates the display device to display, on the screen of the reference information, a button to change the current screen to the list screen showing the original list (for example, a button of “RETURN” in the Web page shown in FIG. 15A). In this way, the system control section 101 of the information displaying apparatus is configured to display the list screen and the screen showing reference information such that a user can move from one of the list screen and the screen showing the reference information to the other of those screens by using the link icon and the button of “RETURN”, which allows a user to also confirm reference information related to the document information and thereby to makes user's comprehension of the document easy.

Here, the present invention should not be limited to the above-mentioned examples. That is, the constitution and control of the present invention can be modified appropriately unless the modification deviates from the intention of the present invention.

For example, though the documents including only character strings are exemplified in the above-mentioned examples, the system control section 101 can create a list similarly to a document including figures and images to manage areas to which additional information has been inputted. In this case, in order to avoid the missing of a part of each of the figure and the image in the document, the system control section 101 is preferably configured to correct each input area so as to cover the whole of the figure and the image with which the additional information overlaps. Further, it is preferable that the display position of the button of “RETURN” is arranged to be movable to another position in case that the display position of the button of “RETURN” becomes obstacle to the reading of the original image.

1. An information displaying apparatus comprising:
a display section configured to display a document screen showing a document thereon;
an operating section configured to receive an input of additional information inputted into the document displayed on the display section;
an input area defining section configured to define an area or areas on the display section, the area or areas including the additional information inputted through the operating section;
an information extracting section configured to extract the additional information inputted into each of the area or areas and document information being information of the document displayed in the each of the area or areas; and
an associating processing section configured to register the additional information and the document information with being associated together.

2. The information displaying apparatus of claim 1, further comprising a property extracting section configured to extract property information of the additional information or property information of the additional information and the document information,
wherein the associating processing section is configured to register the additional information, the document information and the property information with being associated together.

3. The information displaying apparatus of claim 2,
wherein the associating processing section is configured to create a list including the additional information, the document information and the property information grouped according to the area or areas, and operate the display section to display a list screen showing the list.

4. The information displaying apparatus of claim 3,
wherein the associating processing section is configured to sort items of the list according to the property information and operate the display section to display the list screen showing the list including the sorted items.

5. The information displaying apparatus of claim 3,
wherein the associating processing section is configured to define a page of the document as a source of the document information based on the property information and operate the display section to display the list screen and the document screen showing the page of the document such that a user can move from one of the list screen and the document screen showing the page of the document to the other.

6. The information displaying apparatus of claim 5,
wherein the associating processing section is configured to, under a situation that reference information is associated with the page of the document as the source of the document information, operate the display section to display the list screen and a screen showing the reference information such that a user can move from one of the list screen and the screen showing the reference information to the other.

7. The information displaying apparatus of claim 3,
wherein the associating processing section is configured to operate the display section to display the list screen so as to allow a user to select one of a display style that the additional information and the document information are displayed with being overlapped together and a display style that the additional information and the document information are displayed separately.

8. The information displaying apparatus of claim 3,
wherein the associating processing section is configured to, in response to the operating section receiving an input of another additional information inputted into one of a certain area on the document screen and a corresponding area on the list screen, the certain area on the document screen being the area or areas including the additional information, reflect the another additional information to the other of the certain area on the document screen and the corresponding area on the list screen.

9. The information displaying apparatus of claim 1,
wherein the input area defining section is configured to, on or after defining each of the area or areas, correct at least one of size and shape of the each of the area or areas according to the document information displayed in the each of the area or areas.

10. The information displaying apparatus of claim 3,
wherein the associating processing section is configured to create a file by adding the list to the document as a new page.

11. The information displaying apparatus of claim 1,
wherein the operating section is a touch panel arranged on the display section, and the additional information is handwriting information inputted by handwriting on the touch panel.

12. An information editing method of editing information by using an information displaying apparatus including a display section configured to display a document screen showing a document thereon and an operating section configured to receive an input of additional information inputted into the document displayed on the display section, the method comprising:
defining an area or areas on the display section, the area or areas including the additional information inputted through the operating section;
extracting the additional information inputted into each of the area or areas and document information being information of the document displayed in the each of the area or areas; and
registering the additional information and the document information with being associated together.

13. The information editing method of claim 12, further comprising extracting property information of the additional information or property information of the additional information and the document information,
wherein the registering the additional information and the document information includes registering the additional information, the document information and the property information with being associated together.

14. The information editing method of claim 13, further comprising,
on the registering the additional information, the document information and the property information, creating a list including the additional information, the document information and the property information grouped according to the area or areas, and operating the display section to display a list screen showing the list.

15. The information editing method of claim 14,
wherein the operating the display section to display the list screen includes sorting items of the list according to the property information and operating the display section to display the list screen showing the list including the sorted items.

16. The information editing method of claim 14,
wherein the operating the display section to display the list screen includes defining a page of the document as a source of the document information based on the property information and operating the display section to display the list screen and the document screen showing the page of the document such that a user can move from one of the list screen and the document screen showing the page of the document to the other.

17. The information editing method of claim 16,
wherein the operating the display section to display the list screen includes, under a situation that reference information is associated with the page of the document as the source of the document information, operating the display section to display the list screen and a screen showing the reference information such that a user can move from one of the list screen and the screen showing the reference information to the other.

18. The information editing method of claim 14,
wherein the operating the display section to display the list screen includes operating the display section to display the list screen thereon so as to allow a user to select one of a display style that the additional information and the document information are displayed with being overlapped together and a display style that the additional information and the document information are displayed separately.

19. The information editing method of claim 14,
wherein the operating the display section to display the list screen includes, in response to the operating section receiving an input of another additional information inputted into one of an area on the document screen and a corresponding area on the list screen, the area on the document screen being the area or areas on the document screen, reflecting the another additional information to the other of the area on the document screen and the corresponding area on the list screen.

20. The information editing method of claim 12, further comprising,
on or after the defining the area or areas, correcting at least one of size and shape of the each of the area or areas according to the document information displayed in the each of the area or areas.

21. The information editing method of claim 14,
wherein the creating the list includes creating a file by adding the list to the document as a new page.

22. The information editing method of claim 12,
wherein the operating section is a touch panel arranged on the display section and the additional information is handwriting information inputted by handwriting on the touch panel.

23. A non-transitory computer-readable storage medium storing an information editing program to be executed in an information displaying apparatus including a display section configured to display a document screen showing a document thereon and an operating section configured to receive an input of additional information inputted into the document displayed on the display section, the program, when being executed by a processor of the information displaying apparatus, causing the information displaying apparatus to perform the information editing method of claim 12.
